(19) United States
(12) Patent Application Publication
(10) Pub. No.: US 2020/0410664 A1
(43) Pub. Date: Dec. 31, 2020

(54) MEASUREMENT DEVICE AND MEASUREMENT METHOD

(71) Applicant: Panasonic Intellectual Property Management Co., Ltd., Osaka (JP)

(72) Inventors: Taro IMAGAWA, Osaka (JP); Hiroya KUSAKA, Hyogo (JP); Akihiro NODA, Osaka (JP)

(21) Appl. No.: 17/022,646

(22) Filed: Sep. 16, 2020

Related U.S. Application Data
(63) Continuation of application No. PCT/JP2018/041866, filed on Nov. 12, 2018.

(30) Foreign Application Priority Data
Mar. 26, 2018 (JP) 2018-058926

(51) Int. Cl. G06T 7/00; G06T 7/246; G01N 21/88

(52) U.S. Cl. CPC G06T 7/0004; G06T 7/248; G01N 2021/8864; G01N 21/8803; G01N 2021/8858; G01N 21/8851

(57) ABSTRACT

A measurement device includes: an obtainer that obtains a plurality of images of a support member that movably supports a structure, the plurality of images being captured at mutually different times while the structure is subjected to varying loads; and a measurer that measures displacement of the support member based on the plurality of images obtained by the obtainer.

### CROSS REFERENCE TO RELATED APPLICATIONS

This application is a U.S. continuation application of PCT International Patent Application Number PCT/JP2018/041866 filed on Nov. 12, 2018, claiming the benefit of priority of Japanese Patent Application Number 2018-058926 filed on Mar. 26, 2018, the entire contents of which are hereby incorporated by reference.

### BACKGROUND

### 1. Technical Field

The present disclosure relates to measurement of displacement of a support member that movably supports a structure.

### 2. Description of the Related Art

As a technique for examining an appearance of an object, Japanese Unexamined Patent Application Publication No. 2008-139285 discloses a technique of measuring a crack width using an original picture of a structure or a product that is obtained through a camera, for example.

### SUMMARY

Regarding a support member that movably supports a structure, the structure or the support member may be subjected to an unexpected stress when the support member does not undergo motion as predetermined, even if there is no problem with the appearance of the support member. This may lead to a breakage of the structure or the support member.

In view of the above, the present disclosure provides a measurement device and a measurement method that are capable of measuring displacement of a support member that movably supports a structure.

A measurement device according to one aspect of the present disclosure includes: an obtainer that obtains a plurality of images of a support member that movably supports a structure, the plurality of images being captured at mutually different times while the structure is subjected to varying loads; and a measurer that measures displacement of the support member based on the plurality of images obtained by the obtainer.

Moreover, a measurement method according to one aspect of the present disclosure is a measurement method of measuring displacement of a support member that movably supports a structure. The measurement method includes: obtaining a plurality of images of the structure captured at mutually different times while the structure is subjected to varying loads; and measuring displacement of the support member based on the plurality of images.

With the measurement device and the measurement method according to one aspect of the present disclosure, it is possible to measure displacement of a support member that movably supports a structure.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is an external view of an exemplary configuration of a measurement system according to an embodiment;

FIG. 2 is a schematic side view of a support member according to the embodiment;

FIG. 3 is a block diagram of a functional configuration of a measurement device according to the embodiment;

FIG. 4A is a schematic diagram of one or more exemplary principal components of displacement in one or more local regions;

FIG. 4B is a schematic diagram of one or more exemplary principal components of displacement in one or more local regions;

FIG. 4C is a schematic diagram of one or more exemplary principal components of displacement in one or more local regions;

FIG. 4D is a schematic diagram of one or more exemplary principal components of displacement in one or more local regions;

FIG. 5 is a flowchart of a measurement process according to the embodiment;

FIG. 6 is a diagram illustrating an example of a plurality of images according to the embodiment;

FIG. 7 is an external view of an exemplary configuration of a measurement system according to another embodiment; and

FIG. 8 is a schematic diagram of one or more exemplary principal components of displacement in one or more local regions.

### DETAILED DESCRIPTION OF THE EMBODIMENT

These and other objects, advantages and features of the disclosure will become apparent from the following description thereof taken in conjunction with the accompanying drawings that illustrate a specific embodiment of the present disclosure.

### Overview of the Disclosure

The measurement device according to one aspect of the present disclosure includes: an obtainer that obtains a plurality of images of a support member that movably supports a structure, the plurality of images being captured at mutually different times while the structure is subjected to varying loads; and a measurer that measures displacement of the support member based on the plurality of images obtained by the obtainer.

With the measurement device having the above configuration, it is possible to measure displacement of a support member that movably supports a structure.

Moreover, the measurement device may further include: a determiner that performs determination whether the support member undergoes predetermined motion, based on the displacement of the support member that is measured by the measurer.

This enables a user who uses the measurement device having the above configuration to know whether the support member undergoes predetermined motion.

Moreover, the measurement device may further include an extractor that extracts one or more principal components by performing a multivariate analysis on the displacement of the support member that is measured by the measurer. The determiner may perform the determination based on the one or more principal components extracted by the extractor.

This enables the measurement device having the above configuration to determine whether the support member undergoes predetermined motion, based on one or more characteristic components among one or more components of the displacement of the support member. Therefore, the measurement device having the above configuration more accurately determines whether the support member undergoes predetermined motion.

Moreover, the structure may be a bridge girder, the support member may be a bearing, and the predetermined motion may include rotation.

With this, the measurement device having the above configuration determines whether a bearing that rotatably supports a bridge girder undergoes rotational motion as predetermined.

Moreover, the structure may be a bridge girder, the support member may be a bearing, and the predetermined motion may include sliding.

With this, the measurement device having the above configuration determines whether a bearing that slidably supports a bridge girder undergoes sliding motion as predetermined.

Moreover, the structure may be a bridge girder of a suspended structure, the support member may be a cable of the suspended structure, and the predetermined motion may include motion in a direction perpendicular to a direction in which the cable is pulled.

With the measurement device having the above structure, it is possible to determine whether a cable that movably supports the bridge girder of the suspended structure undergoes the predetermined displacement motion in a direction perpendicular to a direction in which the cable is pulled.

Moreover, the structure may be a bridge girder of a suspended structure, the support member may be a cable of the suspended structure, and the extractor may obtain one or more frequencies of the one or more principal components or tensile force of the cable based on the one or more frequencies. The determiner may perform the determination based on the one or more frequencies of the one or more principal components extracted by the extractor or the tensile force.

With this, it is possible to determine whether the one or more frequencies of vibration motion of the cable which movably supports the bridge girder of the suspended structure is as predetermined or whether the tensile force when the cable displaces is as predetermined.

Moreover, the measurement device may further include an imaging unit configured to capture the plurality of images.

Accordingly, with the measurement device having the above configuration, displacement of the support member that movably supports the structure may be measured without obtaining images from an outside source.

Moreover, a measurement method according to one aspect of the present disclosure is a measurement method of measuring displacement of a support member that movably supports a structure. The measurement method includes: obtaining a plurality of images of the structure captured at mutually different times while the structure is subjected to varying loads; and measuring displacement of the support member based on the plurality of images.

With the measurement method according to one aspect of the present disclosure, it is possible to measure displacement of a support member that movably supports a structure.

Specific examples of the measurement device according to one aspect of the present disclosure will be described below, with reference to the drawings. Each embodiment described below shows a specific example of the present disclosure. Therefore, numerical values, shapes, structural components, the arrangement and connection of the structural components, steps, order of the steps, etc. shown in the following embodiment are mere examples, and are not intended to limit the scope of the present disclosure. Of the structural components in the following embodiments, structural components not recited in any one of the independent claims are described as structural components that can be added optionally. Furthermore, the figures are schematic diagrams and are not necessarily precise illustrations.

Note that these comprehensive or specific aspects of the present disclosure may be implemented as a system, a method, an integrated circuit, a computer program, or a computer-readable recording medium such as a CD-ROM, or may be implemented as any combination of a system, a method, an integrated circuit, a computer program, and a recording medium.

### Embodiment

### [Configuration of Measurement System]

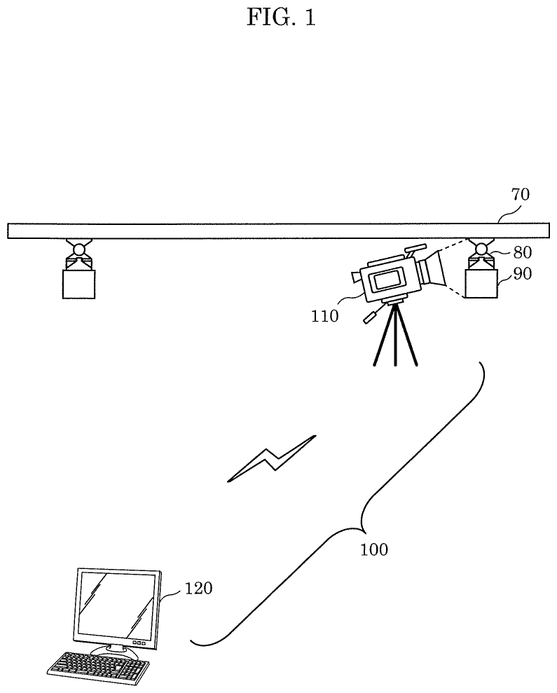

First, an exemplary configuration of a measurement system according to an embodiment will be specifically described below, with reference to FIG. 1. FIG. 1 is an external view of an exemplary configuration of the measurement system according to the embodiment. Measurement system 100 includes imaging device 110 and measurement device 120.

Imaging device 110 is, for example, a digital video camera or a digital still camera that includes an image sensor. Imaging device 110 captures images of support member 80 that movably supports structure 70 over time. The present embodiment describes an example in which structure 70 is a bridge girder, and support member 80 is a bearing that is disposed on bridge pier 90 and movably supports the bridge girder.

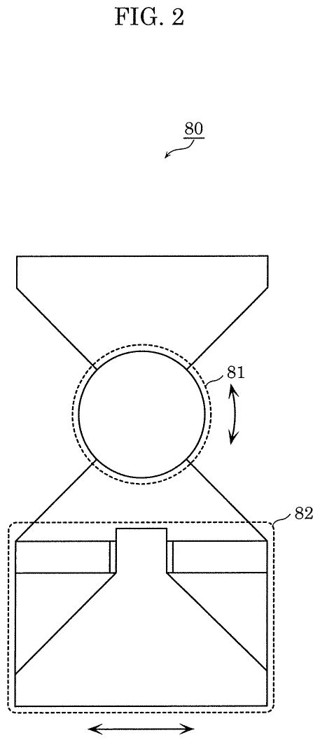

FIG. 2 is a schematic side view of support member 80 in the example in which support member 80 is a bearing.

As in the example illustrated in FIG. 2, support member 80 includes rotatable portion 81 capable of rotating around a rotation axis which lies in a direction perpendicular to the plane, and slidable portion 82 capable of sliding in the lateral direction (horizontal direction) in the figure.

Support member 80 includes rotatable portion 81 and slidable portion 82 to rotatably and slidably support structure 70 (bridge girder). Accordingly, the predetermined motion of support member 80 includes rotation and sliding.

Note that structure 70 does not necessarily need to be limited to the bridge girder and support member 80 does not necessarily need to be limited to the bearing. As an example, structure 70 may be a compressor, and support member 80 may be a damper that attaches a compressor on a wall of a building. Moreover, as another example, structure 70 may be a house and support member 80 may be a base isolation mechanism disposed between the foundation and the house. The base isolation mechanism may be a laminated rubber, for example.

With reference to FIG. 1 again, measurement system 100 will be further described.

Specifically, imaging device 110 captures images of support member 80 while structure 70 is subjected to varying loads. For example, if structure 70 is a bridge girder and support member 80 is a bearing, a plurality of images are captured, for example, when a vehicle is traveling on the bridge girder and some kind of force is applied to the bridge girder by wind and so on.

The images include an identical portion of support member 80 and are captured at mutually different times. More specifically, the images are a plurality of frames included in a video, for example.

Measurement device 120, an example of which is a computer, includes a processor (not illustrated) and a memory (not illustrated) that stores a software program or instructions. Measurement device 120 achieves its functions described below by the processor executing the software program. Moreover, measurement device 120 may include a dedicated electronic circuit (not illustrated). In this case, the functions of measurement device 120 described below may be implemented by individual electronic circuits or an integrated electronic circuit.

Measurement device 120 is connected to imaging device 110 such that, for example, measurement device 120 is able to communicate with imaging device 110. Measurement device 120 measures displacement of support member 80 based on the images captured by imaging device 110.

### [Functional Configuration of Measurement Device]

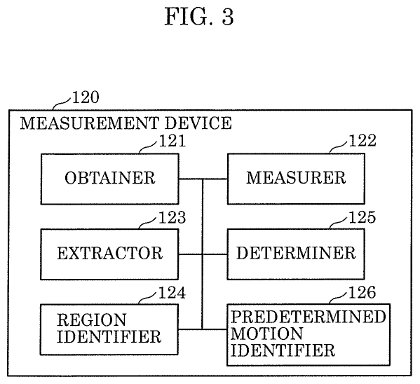

Next, a functional configuration of measurement device 120 according to the embodiment will be described below with reference to FIG. 3.

FIG. 3 is a block diagram of a functional configuration of measurement device 120 according to the embodiment. As illustrated in FIG. 3, measurement device 120 includes obtainer 121, measurer 122, extractor 123, region identifier 124, determiner 125, and predetermined motion identifier 126.

Obtainer 121 obtains a plurality of images of support member 80 that movably supports structure 70. The images are captured at mutually different times while structure 70 is subjected to varying loads. For example, obtainer 121 obtains the images from imaging device 110 by wireless communication. Furthermore, obtainer 121 may obtain the images from imaging device 110 via, for example, a detachable memory such as a universal serial bus (USB) memory.

Measurer 122 measures displacement of support member 80 based on the images obtained by obtainer 121. More specifically, measurer 122 measures displacement in each local region on the surface of support member 80. The local region may be a region corresponding to one pixel or a region corresponding to a plurality of pixels. Measurer 122 may calculate, for example, a motion vector in each local region as displacement in each local region. In this case, measurer 122 calculates the motion vector in each local region by performing motion estimation on each local region by using a block matching method, for example.

Extractor 123 extracts one or more principal components by performing a multivariate analysis on displacement of support member 80 that is measured by measurer 122. More specifically, extractor 123 extracts one or more principal components by performing a multivariate analysis on displacement in each local region included in an identification region identified by region identifier 124, among the local regions measured by measurer 122. Region identifier 124 will be described later. An example of the multivariate analysis is a principal component analysis.

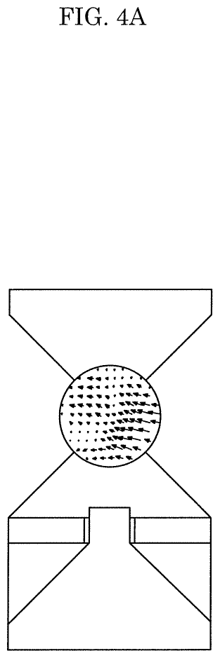

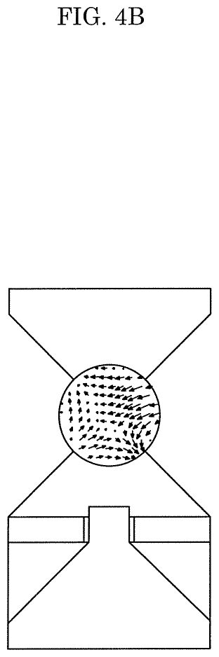

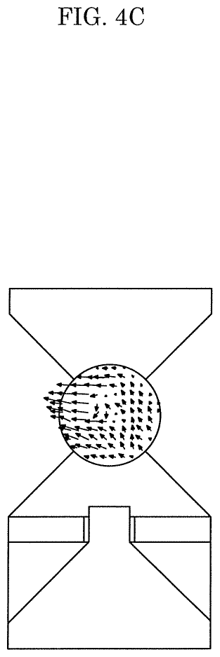

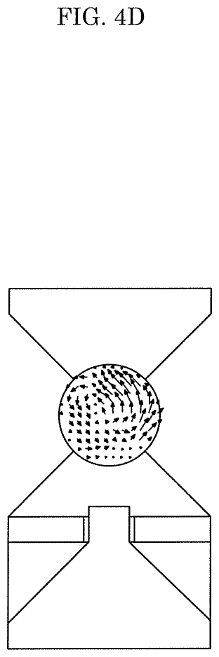

FIG. 4A through FIG. 4D are schematic diagrams of one or more exemplary principal components of displacement in one or more local regions that are extracted by extractor 123 when the identification region that is to be identified by region identifier 124 is rotatable portion 81. FIG. 4A illustrates a first principal component of displacement of one or more local regions, FIG. 4B illustrates a second principal component of displacement of one or more local regions, FIG. 4C illustrates a third principal component of displacement of one or more local regions, and FIG. 4D illustrates a fourth principal component of displacement of one or more local regions. Each of the arrows in FIG. 4A through FIG. 4D is an orientation and a distance of displacement in each local region.

As illustrated in FIG. 4D, the fourth principal component of displacement in one or more local regions of rotatable portion 81 indicates rotation of rotatable portion 81.

Note that it is sufficient that extractor 123 extracts one or more principal components by performing a multivariate analysis on displacement of support member 80 that is measured by measurer 122. Extractor 123 does not necessarily need to be limited to the exemplary configuration in which one or more principal components are extracted by performing a multivariate analysis on displacement in each local region included in an identification region identified by region identifier 124, among the displacement in each of the one or more local regions measured by measurer 122. For example, extractor 123 may extract one or more principal components by performing a multivariate analysis on all of the displacement in one or more local regions on the surface of support member 80.

Region identifier 124 identifies an identification region including one or more local regions which are to be subjected to extraction of one or more principal components performed by extractor 123. For example, region identifier 124 may include a user interface (a touch panel, for instance), and may identify, as an identification region, a region specified by a user based on an input operation performed by the user who uses measurement device 120. Moreover, region identifier 124 may identify a region including a movable portion of support member 80 as an identification region by performing artificial intelligence (AI) processing including image recognition processing on the images obtained by obtainer 121, for example.

Moreover, determiner 125 determines whether support member 80 undergoes predetermined motion, based on displacement of support member 80 that is measured by measurer 122. More specifically, determiner 125 determines whether support member 80 undergoes the predetermined motion, based on the one or more principal components extracted by extractor 123. For example, determiner 125 determines that support member 80 undergoes the predetermined motion when one or more principal components indicating the predetermined motion identified by predetermined motion identifier 126 are present in the one or more principal components extracted by extractor 123, and determines that support member 80 does not undergo the predetermined motion when the one or more principal components indicating the predetermined motion are absent. Predetermined motion identifier 126 will be described later. As an example, when the predetermined motion to be identified by predetermined motion identifier 126 is rotation of rotatable portion 81, determiner 125 determines that support member 80 undergoes the predetermined motion when the one or more principal components indicating rotation of rotatable portion 81 as shown in FIG. 4D are present among the one or more principal components in the one or more local regions extracted by extractor 123.

Note that it is sufficient that determiner 125 is configured to determine whether support member 80 undergoes the predetermined motion based on the displacement of support member 80 measured by measurer 122. Determiner 125 does not necessarily need to be limited to the exemplary configuration in which determiner 125 performs such a determination based on the one or more principal components extracted by extractor 123.

Predetermined motion identifier 126 identifies the predetermined motion of support member 80. For example, predetermined motion identifier 126 may include a user interface (a touch panel, for instance), and identify, based on an input operation by a user who uses measurement device 120, motion specified by the user as the predetermined motion of support member 80. Furthermore, region identifier 124 may identify the predetermined motion of support member 80 by performing AI processing including image recognition processing on the images obtained by obtainer 121, for example.

### [Operations of Measurement Device]

The following describes operations of measurement device 120 having the above configuration.

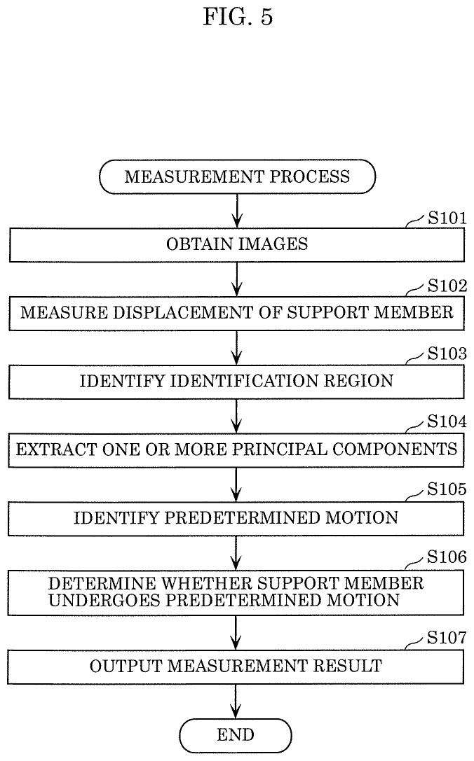

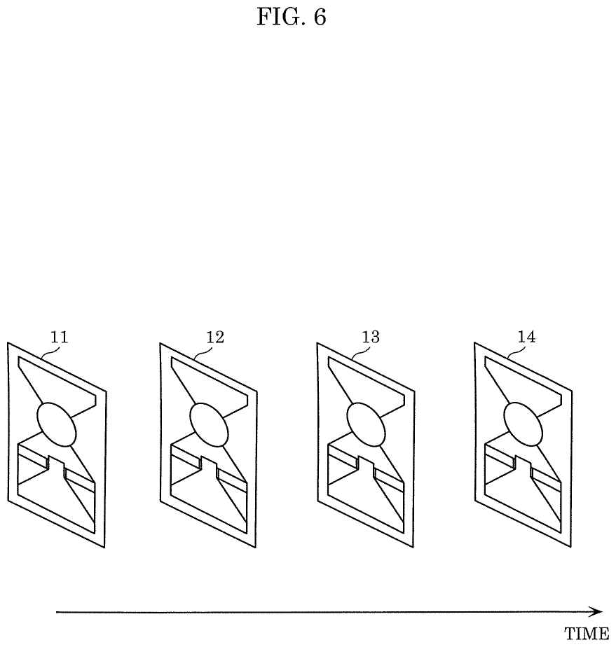

Measurement device 120 performs a measurement process as its characteristic operation. Here, the measurement process performed by measurement device 120 will be described in detail with reference to FIG. 5 and FIG. 6.

FIG. 5 is a flowchart of a measurement process performed by measurement device 120. FIG. 6 is a diagram illustrating an example of a plurality of images according to the embodiment.

The measurement process is a process of measuring displacement of support member 80 that movably supports structure 70. The measurement is performed based on the images captured by imaging device 110.

The measurement process is started, for example, when an operation indicating starting the measurement process is performed on measurement device 120 by a user of measurement device 120.

When the measurement process is started, obtainer 121 obtains images of support member 80 that movably supports structure 70 (step S101). The images are captured at mutually different times while structure 70 is subjected to varying loads.

For example, as illustrated in FIG. 6, obtainer 121 obtain images 11 to 14 that include an identical portion of support member 80 and are captured at mutually different times.

When the images are obtained, measurer 122 measures displacement of support member 80 based on the obtained images (step S102). More specifically, measurer 122 measures displacement in each local region on the surface of support member 80 based on the obtained images.

When displacement of support member 80 is measured, region identifier 124 identifies an identification region including one or more local regions which are to be subjected to extraction of one or more principal components performed by extractor 123 (step S103). For example, region identifier 124 may identify a region specified by a user as the identification region, or identify a region including a movable portion of support member 80 as the identification region by, for example, performing AI processing including image recognition processing on the images obtained by obtainer 121.

Note that the processing of step S103 does not necessarily need to be performed after the processing of step S102. The processing of step S103 may be performed, for example, in parallel with the processing of step S102, or before the processing of step S102.

When an identification region is identified, extractor 123 extracts one or more principal components by performing a multivariate analysis on displacement of support member 80 (step S104). More specifically, extractor 123 extracts one or more principal components by performing a multivariate analysis on displacement in each local region included in the identification region that is identified by region identifier 124, among the one or more local regions measured by measurer 122.

When the one or more principal components are extracted, predetermined motion identifier 126 identifies predetermined motion of support member 80 (step S105). For example, predetermined motion identifier 126 may identify motion specified by a user as the predetermined motion, or identify predetermined motion by, for example, performing AI processing including image recognition processing on the images obtained by obtainer 121.

Note that the processing of step S105 does not necessarily need to be performed after the processing of step S104. The processing of step S105 may be performed, for example, in parallel with the processing of step S104, or before the processing of step S104.

When the predetermined motion is identified, determiner 125 determines whether support member 80 undergoes the predetermined motion, based on the displacement of support member 80 measured by measurer 122. More specifically, determiner 125 determines that support member 80 undergoes the predetermined motion when one or more principal components indicating the predetermined motion identified by predetermined motion identifier 126 are present in the one or more principal components extracted by extractor 123, and determines that support member 80 does not undergo the predetermined motion when the one or more principal components indicating the predetermined motion are absent.

Lastly, determiner 125 outputs, as a measurement result, the displacement of support member 80 and the determination result regarding whether support member 80 undergoes predetermined motion (step S106). For example, determiner 125 displays the measurement result on a display (not illustrated). Also, determiner 125 may transmit the measurement result to, for example, another device such as a smart phone or a tablet computer.

### [Consideration]

As described above, measurement device 120 measures displacement of the support member that movably supports the structure. Measurement device 120 then performs determination whether the support member undergoes the predetermined motion. Thus, a user who uses measurement device 120 can obtain knowledge regarding a possibility of breakage of the structure or the support member due to an unexpected stress applied to the structure or the support member.

### OTHER EMBODIMENTS

The measurement device according to one or more aspects of the present disclosure has been described above on the basis of the embodiment, but the present disclosure is not limited to the embodiment.

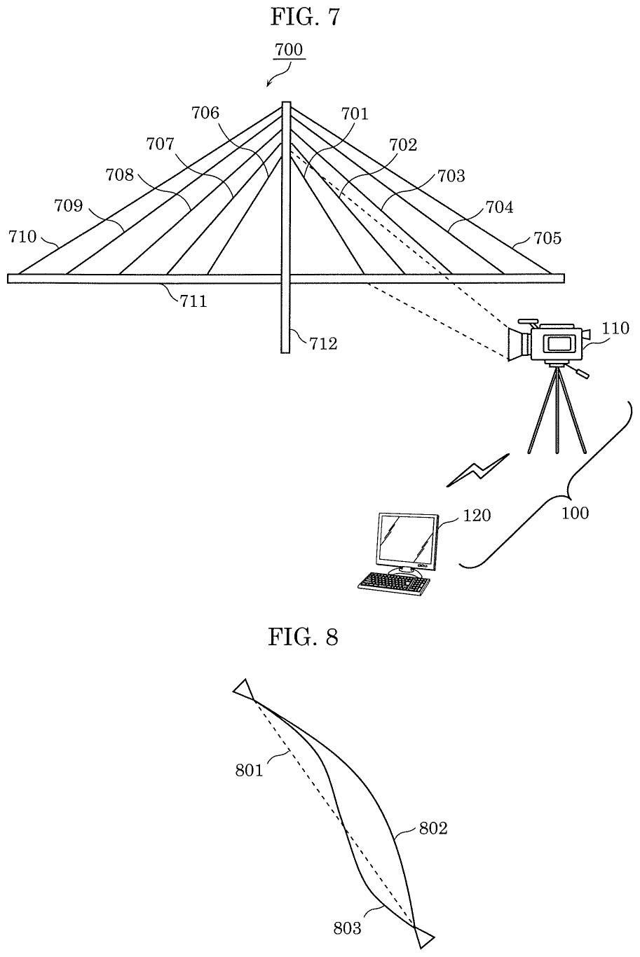

For example, the following describes an example of a cable stayed bridge. Here, the structure is a bridge girder and the support member is a cable. FIG. 7 is an external view of an exemplary measurement system according to another embodiment. In cable stayed bridge 700 in FIG. 7, the structure is bridge girder 711 and the support members are cables 701 to 710 that extend from main tower 712. Extractor 123 detects regions of cables 701 to 710 using image recognition from images in which cable stayed bridge 700 is captured, motion in a direction perpendicular to a direction in which each of cables 701 to 710 is pulled by bridge girder 711 and main tower 712 is obtained, and extracts one or more frequencies of one or more principal components for each cable.

FIG. 8 is a schematic diagram of one or more exemplary principal components of displacement in local regions. FIG. 8 illustrates a result of extracting first principal component 802 and second principal component 803 of the displacement of one cable. In FIG. 8, broken line 801 indicates a position of the cable at rest. Predetermined motion may be determined by using one or more amplitudes of one or more vibrations or obtaining one or more frequencies of one or more principal components and determining whether the one or more frequencies are included in one or more predetermined ranges. The varying loads may be applied using a load of a vehicle passing on bridge girder 711 and forced vibrations applied to cables 701 to 710 by, for example, a hammer or hand.

Moreover, extractor 123 may calculate tensile force on the cables based on the one or more frequencies of the one or more principal components, and determine whether the tensile force on each cable is a value within a predetermined range. The method described in Tohru SHINKE, et al, “PRACTICAL FORMULAS FOR ESTIMATION OF CABLE TENSION BY VIBRATION METHOD”, Proc. Jpn. Soc. Civ. Eng., No. 294, 1980 may be used to calculate the tensile force based on one or more frequencies of the cables.

Moreover, as an example of a structure having cables, other than the cable stayed bridge, a suspended structure such as a suspension bridge or a structure that transmits electric power may be a target of the measurement.

Furthermore, one or more aspects of the present disclosure may include, without departing from the essence of the present disclosure, one or more variations achieved by making various modifications to the present disclosure that can be conceived by those skilled in the art or one or more embodiments achieved by combining structural components in different embodiments.

For example, although the measurement device does not include the imaging device in the above embodiment, the measurement device may include the imaging device. In this case, the imaging device functions as an imaging unit which is a part of the measurement device.

Moreover, a plurality of functional components included in the measurement device (obtainer, measurer, extractor, region identifier, determiner, predetermined motion identifier, etc.) may be implemented by distributed computing or cloud computing.

Note that the above embodiment describes an example of using block matching for motion estimation, but the present disclosure is not limited to this example. For example, motion estimation may be performed by matching between other local image features such as those of histogram of oriented gradients (HOG) and scaled invariance feature transform (SIFT).

One or more, or all of the structural components included in the measurement device according to the embodiment may be implemented as a system large scale integration (LSI). For example, measurement device 120 may be implemented as a system LSI that includes obtainer 121, measurer 122, extractor 123, region identifier 124, determiner 125, and predetermined motion identifier 126.

The system LSI is a super-multifunctional LSI that is manufactured by integrating a plurality of components onto one chip. The system LSI is more specifically a computer system that includes a microprocessor, a read only memory (ROM), a random access memory (RAM), and so forth. The ROM stores a computer program. The microprocessor operating in accordance with the computer program enables the system LSI to accomplish its functions.

Although a system LSI is described here as an example, the chip may also be referred to as an integrated circuit (IC), an LSI, a super LSI, or an ultra LSI, depending on the degree of integration. Also, a method of IC implementation is not limited to an LSI. Each of the structural components may thus be implemented as a dedicated circuit or a general-purpose processor. A field programmable gate array (FPGA) that allows for programming after the manufacture of an LSI, or a reconfigurable processor that allows for reconfiguration of the connection and settings of circuit cells inside an LSI may be employed.

Furthermore, when a new IC technology replaces LSI owing to the progress in the semiconductor technology or another derivative technology, such new technology may certainly be employed for the integration of the functional blocks. For example, application of biotechnology is possible.

Also, an aspect of the present disclosure is not limited to such a measurement device, and thus may be a measurement method that includes as its steps the characteristic components of the measurement device. An aspect of the present disclosure may also be a computer program that causes a computer to execute the characteristic steps included in the measurement method. An aspect of the present disclosure may further be a non-transitory, computer readable recording medium storing such a computer program.

Note that the structural components according to the embodiment may be implemented as dedicated hardware or may be implemented by executing a software program suited to each of the structural components. Alternatively, the structural components may be implemented by a program execution unit such as a CPU and a processor reading out and executing the software program recorded in a recording medium such as a hard disk or a semiconductor memory. Here, the software program that implements the measurement device and so forth according to the embodiment is a program as described below.

In other words, the program causes a computer to execute a measurement method of measuring displacement of a support member that movably supports a structure. The measurement method includes: obtaining a plurality of images of the structure captured at mutually different times while the structure is subjected to varying loads; and measuring displacement of the support member based on the plurality of images.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

The present disclosure is widely applicable for use as a measurement device that measures displacement of a support member that movably supports a structure.

What is claimed is:

1. A measurement device, comprising:
an obtainer that obtains a plurality of images of a support member that movably supports a structure, the plurality of images being captured at mutually different times while the structure is subjected to varying loads; and
a measurer that measures displacement of the support member based on the plurality of images obtained by the obtainer.

2. The measurement device according to claim 1, further comprising:
a determiner that performs determination whether the support member undergoes predetermined motion, based on the displacement of the support member that is measured by the measurer.

3. The measurement device according to claim 2, further comprising:
an extractor that extracts one or more principal components by performing a multivariate analysis on the displacement of the support member that is measured by the measurer, wherein
the determiner performs the determination based on the one or more principal components extracted by the extractor.

4. The measurement device according to claim 2, wherein
the structure is a bridge girder,
the support member is a bearing, and
the predetermined motion includes rotation.

5. The measurement device according to claim 2, wherein
the structure is a bridge girder,
the support member is a bearing, and
the predetermined motion includes sliding.

6. The measurement device according to claim 2, wherein
the structure is a bridge girder of a suspended structure,
the support member is a cable of the suspended structure, and
the predetermined motion includes motion in a direction perpendicular to a direction in which the cable is pulled.

7. The measurement device according to claim 3, wherein
the structure is a bridge girder of a suspended structure,
the support member is a cable of the suspended structure,
the extractor obtains one or more frequencies of the one or more principal components or tensile force of the cable based on the one or more frequencies, and
the determiner performs the determination based on the one or more frequencies of the one or more principal components extracted by the extractor or the tensile force.

8. The measurement device according to claim 1, further comprising:
an imaging unit configured to capture the plurality of images.

9. A measurement method of measuring displacement of a support member that movably supports a structure, the measurement method comprising:
obtaining a plurality of images of the structure captured at mutually different times while the structure is subjected to varying loads; and
measuring displacement of the support member based on the plurality of images.
